(19) United States
(12) Patent Application Publication
(10) Pub. No.: US 2004/0098642 A1
(43) Pub. Date: May 20, 2004

(54) Computer system for dumping and formatting application data structure

(75) Inventors: Greg J. Kaszycki, Cary, NC (US); John M. Lake, Cary, NC (US); Jonathan G. Rossie, Cary, NC (US); Jonathan Sobel, Cary, NC (US)

Correspondence Address: Frank C. Nicholas, CARDINAL LAW GROUP, Suite 2000, 1603 Orrington Avenue, Evanston, IL, 60201, US

(73) Assignee: International Business Machines Corporation, Armonk, NY (US)

(21) Appl. No.: 10/294,154

(22) Filed: Nov. 14, 2002

(51) Int. Cl. H04L 1/22

(52) U.S. Cl. 714/45

(57) ABSTRACT

Subsequent to a loading of an application program within a first memory space, a first buffer is established within a second memory space and a second buffer is established within a third memory space. The first buffer is operated to store information corresponding to an execution of the application program. The second buffer is operated to store information corresponding to an operating system supporting the execution of the application program. Additionally, a third buffer is established within a fourth memory space, the third buffer being operated to store information indicative of the second memory space and the third memory space to thereby facilitate an examination of the first buffer and the second buffer without any cooperation from the application program and the operating system.

### FIELD OF THE INVENTION

In general, the present invention enables examination of application-internal data structures through operating system mechanisms by an independent third party. Specifically, the present invention provides a technique for safe collaboration between the operating system and the application for the purpose of allowing a third entity or entities (e.g., a program, a programmer, etc) to extract information from the application's data area without disrupting the application's control flow.

### BACKGROUND OF THE INVENTION

A bug within an application program is an error in a code of the application process or a logical structure of the application program that causes the application process to malfunction or to produce incorrect results. Consequently, the bug must be found and corrected (i.e., debugged). While many known debuggers and approaches to debugging involve capturing the current call stack and state of an erroneous application program, such debuggers and approaches do not capture information about how the application program got into the failure state. Debuggers are primarily based upon allowing a programmer to step through the application process and observe the changes in state, which can inadvertently change the temporal behavior of the erroneous application program whereby the problem may be masked or a correction of the problem may be rendered impossible. Other debuggers are based on logging techniques, but they typically require the program to respond to requests to display the contents of the debug/event log, or use scarce (persistent) resources elsewhere in the computing system. Similarly, often events the process itself cannot observe (e.g., events within the operating system) are relevant to the debugging exercise.

The present invention addresses the aforementioned drawbacks.

### SUMMARY OF THE INVENTION

One form of the present invention is a computer system comprising means for loading an application program in a first memory space. The computer system further comprises means for establishing a first buffer within a second memory space subsequent to the loading of the application program within the first memory space, the first buffer operable to store information corresponding to an execution of the application program. The computer system also comprises means for establishing a second buffer within a third memory space subsequent to the loading of the application program within the first memory space, the second buffer operable to store information corresponding to an operating system associated with the execution of the application program.

In a second form, the present invention is a computer program product in a computer readable medium, the computer program product comprising computer readable code for loading an application program in a first memory space. The computer program product further comprises computer readable code for establishing a first buffer within a second memory space subsequent to the loading of the application program within the first memory space, the first buffer operable to store information corresponding to an execution of the application program. The computer program product also comprises computer readable code for establishing a second buffer within a third memory space subsequent to the loading of the application program within the first memory space, the second buffer operable to store information corresponding to an operating system associated with the execution of the application program.

In a third form, the present invention is a method comprising a loading an application program in a first memory space. The method further comprises computer an establishment of a first buffer within a second memory space subsequent to the loading of the application program within the first memory space, the first buffer operable to store information corresponding to an execution of the application program. The method also comprises computer an establishment of a second buffer within a third memory space subsequent to the loading of the application program within the first memory space, the second buffer operable to store information corresponding to an operating system associated with the execution of the application program.

In a fourth form, the present invention is a computer system comprising means for loading an application program in a first memory space. The computer system further comprises means for establishing a first buffer within a second memory space subsequent to the loading of the application program within the first memory space, the first buffer operable to store information corresponding to an execution of the application program. The computer system also comprises means for establishing a second buffer within a third memory space subsequent to the loading of the application program within the first memory space, the second buffer operable to store information corresponding to an operating system associated with the execution of the application program.

The foregoing forms as well as other forms, features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 illustrates a block diagram of one embodiment of a computer system in accordance with the present invention;

FIG. 2 illustrates a block diagram of one embodiment of a nonvolatile memory device of the FIG. 1 computer system in accordance with the present invention;

FIG. 3 illustrates a flow chart representative of a method of facilitating a dumping of application data associated with an execution of the application program of FIG. 2 as implemented by the computer system of FIG. 1 in accordance with the present invention;

FIG. 4 illustrates a block diagram of one embodiment of a volatile memory device of the FIG. 1 computer system in accordance with the present invention;

FIG. 5 illustrates a flow chart representative of a registration method of the application program of FIG. 2 as implemented by the computer system of FIG. 1 in accordance with the present invention; and

FIG. 6 illustrates a flow chart representative of a method of dumping data associated with an execution of the application program of FIG. 2 as implemented by the computer system of FIG. 1 in accordance with the present invention.

### DETAILED DESCRIPTION OF THE PRESENTLY PREFERRED EMBODIMENTS

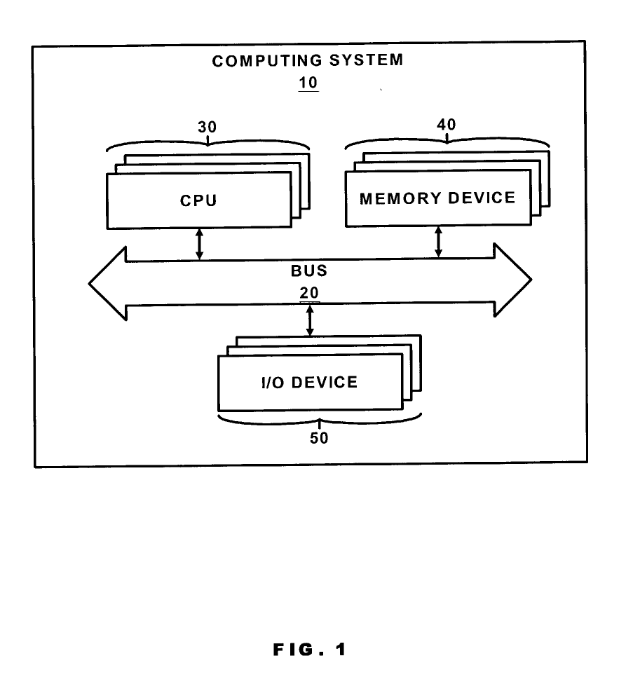

In FIG. 1, a computer system 10 for implementing various methods of the present invention is illustrated. The computer system 10 includes a bus 20 for facilitating communication between one or more conventional central processing units (“CPU”) 30, one or more conventional memory devices 40, and one or more conventional input/output (“I/O”) devices 50. In one embodiment of the present invention, the memory devices 40 include one or more nonvolatile memory devices (e.g., a hard disk) and one or more volatile memory devices (e.g., random access memory). While the computer system 10 is illustrated for purposes of facilitating a description of the various methods of the present invention, the number of hardware configurations of a computer system employing the various methods of the present invention is essentially limitless as will be appreciated by those having ordinary skill in the art.

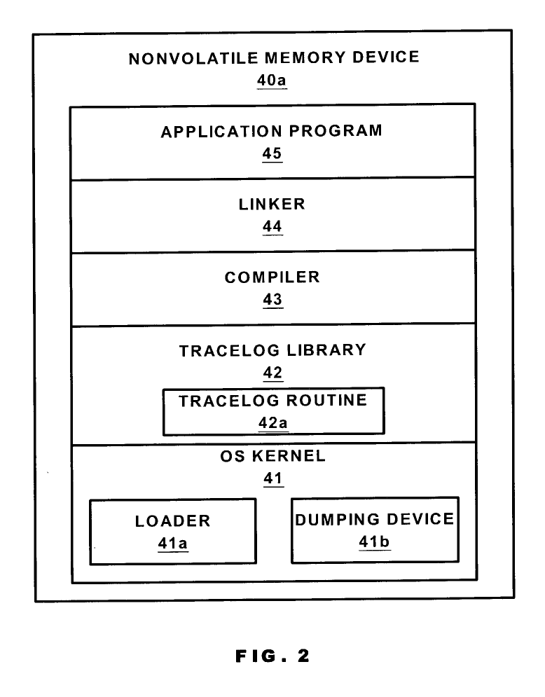

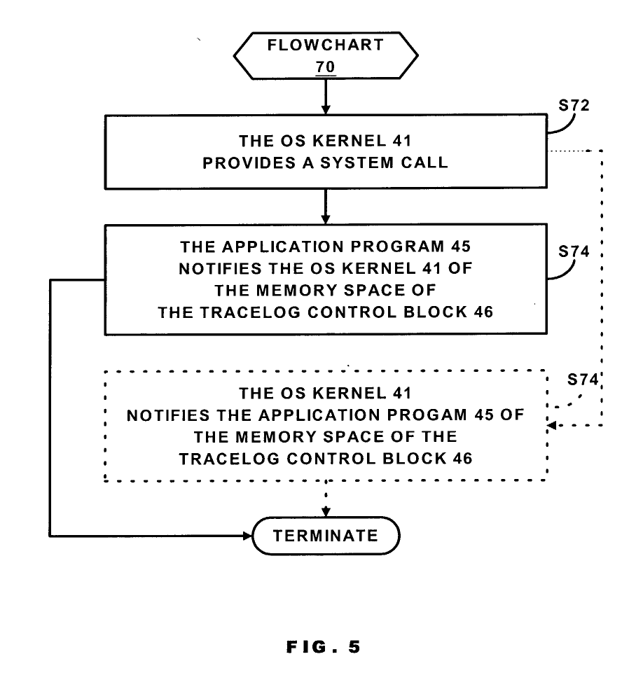

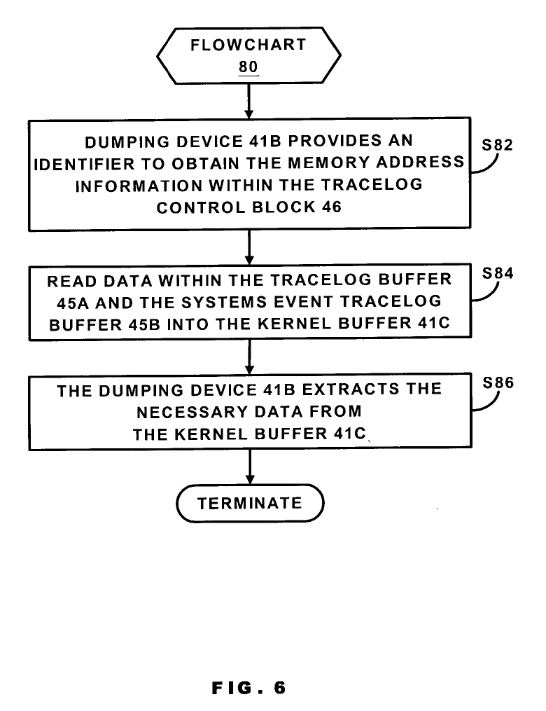

In FIG. 2, various software programs stored within a nonvolatile memory device 40a of memory devices 40 (FIG. 1) are illustrated. The nonvolatile memory device 40a stores an operating system (“OS”) kernel 41 having a conventional loader 41a and a new and unique dumping device 41b in accordance with the present invention. In addition to conventional functions, the OS kernel 41 perform various novel and unique functions in accordance with the present invention as will be subsequently described herein in connection with FIGS. 5 and 6. The nonvolatile memory device 40a further stores a tracelog library 42, a compiler 43, a conventional linker 44, and an application program 45. In addition to conventional routines, the tracelog library 42 includes a novel and unique tracelog routine 42a in accordance with the present invention as will be subsequently described herein in connection with FIGS. 5 and 6. The application program 45 is an executable program having tracing code therein in accordance with a method of the present invention for facilitating a dumping of application data associated with an execution of the application program 45.

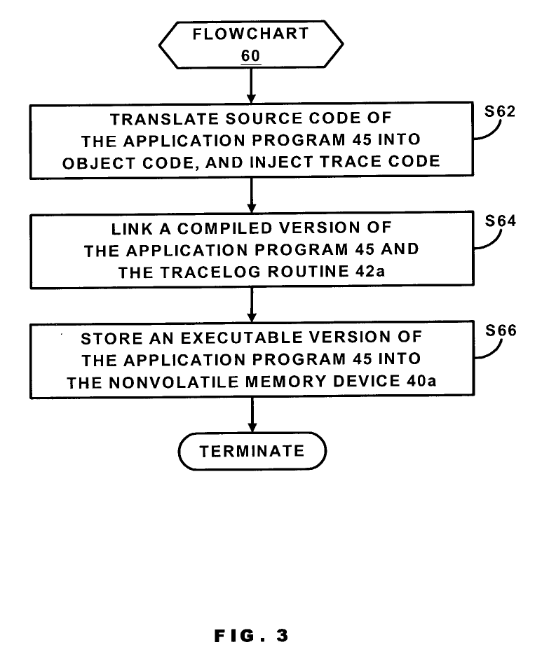

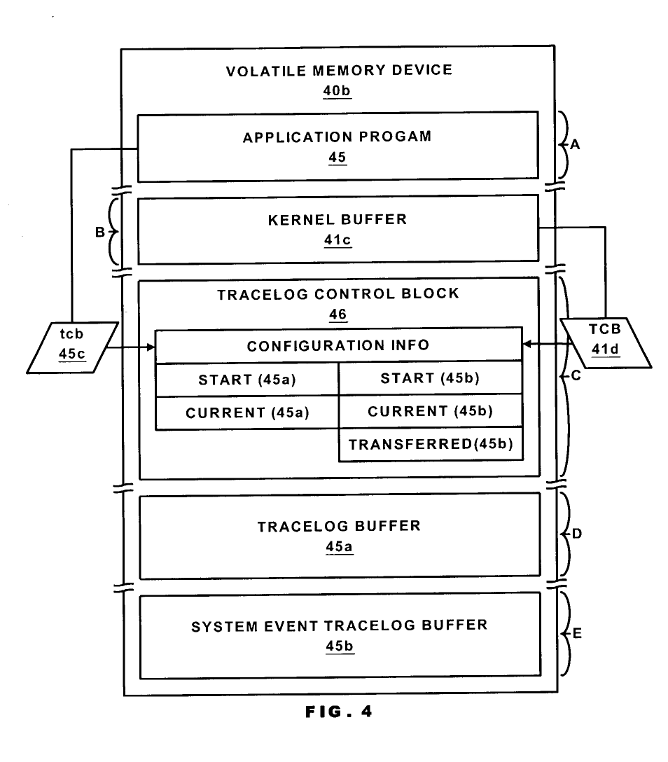

In FIG. 3, a flowchart 60 representative of the method of the present invention for facilitating a dumping of application data associated with an execution of the application program 45 (FIG. 2) is illustrated. During a stage S62 of the flowchart 60, the compiler 43 (FIG. 2) translates a source version of the application program 45 into an object code of the application program 45 whereby the compiler 43 injects the tracing code within the object code to thereby yield a compiled version of the application program 45 having tracing code therein. In an alternate embodiment of the stage S62, the tracing code can be manually inserted within the source version of the application program 45. During a stage S64 of the flowchart 60, the linker 44 (FIG. 2) links the compiled version of the application program 45 to the tracelog routine 42a (FIG. 2) to yield an executable version of the application program 45 having tracing code therein. During a stage S66 of the flowchart 60, the executable version of the application program 45 is stored within the nonvolatile memory device 40a (FIG. 2) for subsequent loading by the loader 41a (FIG. 2) within a volatile memory device 40b (FIG. 4) of the memory devices (40). In an alternate embodiment of the stage S66, the executable version of the application program 45 can be loaded by loader 41a within the volatile memory device 40b (FIG. 4) of the memory devices (40) immediately upon an execution of the stages S62 and S64.

In FIG. 4, various software programs, buffers and data stored within the volatile memory device 40b of memory devices 40 (FIG. 1) are illustrated. Several events occur upon a conventional loading of the application program 45 by the loader 41a (FIG. 2) into a memory space A of the volatile memory device 40b. One set of events involves an establishment of several buffers and a control block within the volatile memory device 40b. In one embodiment, a kernel buffer 41c is established by the OS kernel 41 (FIG. 2) within a memory space B of the volatile memory device 40b. A tracelog control bock 46 is established by the tracelog routine 42a (FIG. 2) within a memory space C of the volatile memory device 40b. And, a tracelog buffer 45a and a systems events tracelog buffer 45b are established by the application program 45 within a pair of memory spaces D and E, respectively, of the volatile memory device 40b.

Another event occurring during a loading of the application program 45 into the memory space A of the volatile memory device 40b is a registration method of the present invention. In FIG. 5, a flowchart 70 representative of the registration method is illustrated. During a stage S72 of the flowchart 70, the OS kernel 41 (FIG. 2) provides a system call corresponding to a registration of the tracelog buffer 45a and the systems events tracelog buffer 45b. During a stage S74 of the flowchart 70, the application program 45 (FIGS. 2 and 4) notifies the OS kernel 41 of a memory space of the tracelog control block 46 within the volatile memory device 40b (FIG. 4) via a pointer TCB 45c (FIG. 4). In an alternative embodiment of the stage S74 as indicated by the dashed lines, the OS kernel 41 notifies the application program 45 of a memory space of the tracelog control block 46 within the volatile memory device 40b via a pointer TCB 41d (FIG. 4) as well as memory spaces for the tracelog buffer 45a and the systems event tracelog buffer 45b within the volatile memory device 40b.

Referring again to FIG. 4, upon a completion of the registration method 70 (FIG. 5), the application program 45 conventionally writes appropriate data to the tracelog buffer 45a and the systems event tracelog buffer 45b, typically using routines from the tracelog library 42 (FIG. 2). The tracelog control buffer 46 contains the necessary configuration information associated with the tracelog buffer 45a and the systems event tracelog buffer 45b. The tracelog control buffer 46 further contains a start memory address START (45a) and a current memory address CURRENT (45a) associated with the tracelog buffer 45a. The tracelog control buffer 46 further contains a start memory address START (45b), a current memory address CURRENT (45b), and a transferred memory address TRANSFERRED (45b) associated with the systems event tracelog buffer 45b. The aforementioned memory addresses are essential to a reading of the contents of the tracelog buffer 45a and the systems event tracelog buffer 45b in accordance with a dumping data method of the present invention.

In FIG. 6, a flowchart 80 representative of the dumping data method of the present invention is illustrated. During a stage S82 of the flowchart 80, the dumping device 41b (FIG. 2) provides an identifier (e.g., /proc/<pid>/tracelog) to obtain the memory address information within the tracelog control block 46 (FIG. 3). During a stage S84 of the flowchart 80, the memory address information is utilized to read data within the tracelog buffer 45a and the systems event tracelog buffer 45b into the kernel buffer 41c (FIG. 3). During a stage S86 of the flowchart 80, the dumping device 41b extracts and optionally formats the necessary data from the kernel buffer 41c to thereby perform conventional debugging techniques.

From the description herein of FIGS. 1-6, those having ordinary skill in the art will appreciate many benefits of the present invention. One of the major benefits is the ability of the dumping device 41b to perform debugging techniques on the data stored within the tracelog buffer 45a and the systems event tracelog buffer 45b while the application program 45 is being executed at full speed in its normal operating context. The following working example of the present invention further highlights various benefits of the present invention.

In the working example, a programmer is trying to ascertain when the application program 45 (FIG. 4) is running, when the application program 45 is suspended by the OS kernel 41 (FIG. 2), and if suspended, why the application program 45 was suspended by the OS kernel 41. The activities of the tracelog buffer 45a (FIG. 4) and the systems event tracelog buffer 45b (FIG. 4) are monitored by the tracelog control block 46 to construct a consistent, time-ordered log of events of the application program 45. The following is an exemplary sequence of relevant events.

A first event involves the application program 45 being conventionally instrumented with calls to _pcml_log to record events including function entry, function exit, and execution of a basic block. The specific instrumentation added may vary according to purpose.

A second event involves a linkage of the application program 45, either statically or dynamically, to the tracelog routine 42a (FIG. 2), which implements the tracelog control block 46.

A third event involves a first call by the application program 45 to _pcml_log, which:

(a) allocates buffer space for the tracelog buffer 45a (e.g., memory space D illustrated in FIG. 4);

(b) allocates buffer space for the systems event tracelog buffer 45b (e.g., memory space E illustrated in FIG. 4);

(c) if /proc/self/trace exists, the_pcml_log tracelog routine 42a informs the OS kernel 41 through a system call of the existence of the buffers 45a and 45b whereby the OS kernel 41 can support the tracelog control block 46. In one embodiment, by the_pcml_log tracelog routine 42a achieves this task by opening Iproc/self/trace and then making an ioctl with the location of the trace control block 46 in the user address space; and

(d) makes an entry in the tracelog buffer 45a.

With an existence of /proc/self/trace, a fourth event involves the OS kernal 41 recording voluntary and involuntary context switches in the systems event tracelog buffer 45b. These appear in the systems event tracelog buffer 45b in pairs (e.g., CSOUT, to mark a context-switch out; and CSIN, to mark a context-switch back), which are copied to the user side log at the time of the next call to _pcml_log.

At any time, the programmer can utter “cat/proc/<10345>/trace” to examine the contents of the tracelog buffer 45a. The OS kernel 41, knowing where to find the information (e.g., due to the ioctl), can dump the contents of the tracelog buffer 45a without further cooperation from the application program 45.

For expository purposes, the application program 45 performs a call proc1 in:

int proc1(int v)
{

int rv = 0;
_{——}pcml_log(FNENTRY, proc1);
for (int i = 0; i < v; ++i)

rv += func1(i, v);

_{——}pcml_log(FNEXIT, proc1);
return rv;

}
int func1(int i, int v)
{

_{——}pcml_log(FNENTRY, func1);
...write(fd, buf, n)...
_{——}pcml_log(FNEXIT, func1);
return ...;

}

We have omitted irrelevant detail in func1, whose main purpose is to call the write(2) system call with the content of the tracelog buffer 45a, which can result in a voluntary context switch under certain conditions (e.g., operating system out of buffer space, for example). We have shown the approximate location of calls to the tracelog control block 46—these calls (_pcml_log) are inserted by the compiler 43 immediately following the procedure prologue and preceding the procedure epilogue in our preferred embodiment, which could put them in slightly different locations than the locations shown here.

At this time, the first call to_pcml_log has already been made, and that the log has roughly the following structure:

user log: (e1, . . . , ek)

system log: (CSOUT, CSIN)

That is, the application program 45 has lost and regained the CPUs 30 (FIG. 1) once since the last user-space log entry was made. Now the application program 45 has the CPUs 30, and makes the call to proc1:

_{——}pcml_log(FNENTRY, proc1) is made, causing:
user log: (e1, ..., ek, CSOUT, CSIN, FNENTRY(proc1))
system log: ( )

The tracelog buffer 45a is presumably filled. The application program 45 then makes a call to

func1:

_{——}pmcl_log(FNENTRY, func1) is made, causing:
user log: (FNENTRY(func1), e2, ..., ek, CSOUT, CSIN,

FNENTRY(proc1))

system log: ( )

This eventually calls write:

write(fd, buf, n) causes a voluntary context switch:
user log: (FNENTRY(func1), e2, ..., ek, CSOUT, CSIN,

FNENTRY(proc1))

system log: (CSOUT)

Eventually the write completes, and the OS kernel 41 gives back the CPUs 30:

user log: (FNENTRY(func1), e2, ..., ek, CSOUT, CSIN,

FNENTRY(proc1))

system log: (CSOUT, CSIN)

Eventually func1 completes, and returns:

_{——}pmcl_log(FNEXIT, func1) is made, causing:
user log: (FNENTRY(func1), CSOUT, CSIN, FNEXIT(func1), e5, ..., ek,

CSOUT, CSIN, FNENTRY(proc1))

system log: ( )

and so forth.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

It is important to note that while the present invention has been described in the context of a fully functioning operating system, those of ordinary skill in the art will appreciate that the processes of the present invention are capable of being distributed in the form a computer program product in a computer readable medium and a variety of other forms, regardless of the particular type of signal bearing media actually used to carry out the distribution. Examples of computer readable media include media such as EPROM, ROM, tape, paper, floppy disc, hard disk drive, RAM, CD-ROM, and transmission-type media, such as digital and analog communications links.

We claim

1. A computer system, comprising:
one or more memory devices;
an application program loaded within a first memory space of said one or more memory devices; and
an operating system for supporting an execution of said application program,
wherein said application program establishes a first buffer within a second memory space of said one or more memory devices subsequent to the loading of said application program within the first memory space, the first buffer operable to store information corresponding to an execution of the application program, and
wherein said application program establishes a second buffer within a third memory space of said one or more memory devices subsequent to the loading of said application program within the first memory space, the second buffer operable to store information corresponding to the operating system during an execution of the application program.

2. The computer system of claim 1, wherein said application program informs said operating system of the second memory space and the third memory space.

3. The computer system of claim 1, wherein said application program establishes a tracelog control block within a fourth memory space of said one or more memory devices subsequent to the loading of said application program within the first memory space, the tracelog control block operable to store information indicative of the second memory space and the third memory space.

4. The computer system of claim 3, wherein said application program registers the tracelog control block with said operating system.

5. The computer system of claim 1, wherein said operating system establishes a tracelog control block within a fourth memory space of said one or more memory devices subsequent to the loading of said application program within the first memory space, the tracelog control block operable to store information indicative of the second memory space and the third memory space.

6. The computer system of claim 5, wherein said operating system registers the tracelog control block with said application program.

7. The computer system of claim 1, further comprising:
a library routine including one or more trace calls inserted into said application program.

8. A computer program product in a computer readable medium, said computer program product comprising:
computer readable code for loading an application program in a first memory space;
computer readable code for establishing a first buffer within a second memory space subsequent to the loading of the application program within the first memory space, the first buffer operable to store information corresponding to an execution of the application program; and
computer readable code for establishing a second buffer within a third memory space subsequent to the loading of the application program within the first memory space, the second buffer operable to store information corresponding to an operating system supporting an execution of the application program.

9. The computer program product of claim 8, further comprising:
computer readable code for informing the operating system of the second memory space and the third memory space.

10. The computer program product of claim 8, further comprising:
computer readable code for establishing a tracelog control block within a fourth memory space subsequent to a loading of the application program, the tracelog control block operable to store information indicative of the second memory space and the third memory space.

11. The computer program product of claim 10, further comprising:
computer readable code for registering the tracelog control block subsequent to the loading of the application program within the first memory space.

12. The computer program product of claim 8, further comprising:
computer readable code for inserting one or more trace calls of a library routine into the application program; and
computer readable code for linking the application program to the library routine.

13. The computer program product of claim 8, further comprising
computer readable code for formatting the information within the first buffer and the second buffer without any cooperation from the application program and the operating system.

14. The computer program product of claim 8, further comprising:
computer readable code for examining the information from the first buffer and the second buffer to thereby debug the execution of the application program without any cooperation from the application program and the operating system.

15. A method of executing an application program, comprising:
loading the application program in a first memory space;
establishing a first buffer within a second memory space subsequent to the loading of the application program within the first memory space, the first buffer operable to store information corresponding to an execution of the application program; and
establishing a second buffer within a third memory space subsequent to the loading of the application program within the first memory space, the second buffer operable to store information corresponding to an operating system supporting an execution of the application program.

16. The method of claim 15, further comprising:
informing the operating system of the second memory space and the third memory space.

17. The method of claim 15, further comprising:
establishing a tracelog control block within a fourth memory space subsequent to a loading of the application program, the tracelog control block operable to store information indicative of the second memory space and the third memory space.

18. The method of claim 17, wherein an operating system is operated to establish the tracelog control block with the fourth memory space.

19. The method of claim 17, wherein the application program is operated to establish the tracelog control block with the fourth memory space.

20. The method of claim 17, further comprising:
registering the tracelog control block subsequent to the loading of the application program within the first memory space.

21. The method of claim 20, wherein an operating system is operated to register the tracelog control block with the application program.

22. The method of claim 20, wherein the application program is operated to register the tracelog control block with the operating system.

23. The method of claim 15, further comprising:
inserting one or more trace calls of a library routine into the application program; and
linking the application program to the library routine.

24. The method of claim 15, further comprising
formatting the information within the first buffer and the second buffer without any cooperation from the application program and the operating system.

25. The method of claim 15, further comprising:
examining the information from the first buffer and the second buffer to thereby debug the execution of the application program without any cooperation from the application program and the operating system.

26. A computer system, comprising:
means for loading an application program in a first memory space;
means for establishing a first buffer within a second memory space subsequent to the loading of the application program within the first memory space, the first buffer operable to store information corresponding to an execution of the application program; and
means for establishing a second buffer within a third memory space subsequent to the loading of the application program within the first memory space, the second buffer operable to store information corresponding to an operating system supporting an execution of the application program.
